(19) United States
(12) Patent Application Publication
(10) Pub. No.: US 2026/0013543 A1
(43) Pub. Date: Jan. 15, 2026

(54) COATING APPARATUS FOR APPLYING CONFECTIONARY COATINGS TO SUBSTRATES, TOOLS, KITS, AND METHODS FOR USE

(71) Applicant: ELC11:11, Bath, PA (US)

(72) Inventors: Marcella Elaine Taylor, Bath, PA (US); Tyla Elizabeth SMITH, Danielsville, PA (US); Thomas Lee SCHLENER, JR., Schnecksville, PA (US); Walter Jeffrey SHAKESPEARE, Macungie, PA (US)

(21) Appl. No.: 19/263,934

(22) Filed: Jul. 9, 2025

Related U.S. Application Data
(60) Provisional application No. 63/669,858, filed on Jul. 11, 2024.

(51) Int. Cl. A23P 20/17; B05C 3/00; B05C 3/09

(52) U.S. Cl. CPC A23P 20/17; B05C 3/005; B05C 3/09

(57) ABSTRACT

The present invention relates to a coating apparatus for a fluidifiable composition, preferably a fluidifiable confectionary composition, the coating apparatus having a central cavity having a maximum transverse distance “D” and a maximum height “L”, wherein the ratio of D:L is at least 1:2.5, to as much as 1:15. In particularly preferred embodiments the coating apparatus is used to apply a fluidified confectionary composition onto an edible substrate. Also disclosed is a removeable vessel and/or reducing insert useful with the coating apparatus, constructed of thermally transmissive material and having a wall thickness such that the vessel or reducing insert wall conducts heat from the base heater to maintain a roughly uniform wall temperature from the base to the top, as well as methods of use of the foregoing.

The present application claims priority to U.S. Application Ser. No. 63/669,858, filed 11 Jul. 2024, and US design patent application Ser. No. 30/012,252, filed 9 Jul. 2025, the entirety of each of the foregoing is herein incorporated by reference thereto.

The present invention, amongst its various aspects, is directed to (i) a coating apparatus, adapted for the application of coatings, preferably of fluidified confectionary compositions onto edible substrates, it is to be appreciated that the (i) coating apparatus may be also used with inedible materials for application onto other substrates and used in other applications, including application of wax or inedible coatings onto an inedible substrate, i.e, a wick, as well as jewelry cleaning applications or other immersible applications, specifically focused on high aspect ratio geometries; (ii) tools useful with the coating apparatus; (iii) kits comprising one or more of (i), (ii) or (i) with (ii); and (iv) methods of use of any of the foregoing.

In one aspect the present invention is directed to (i) a coating apparatus which is used for the application of edible coatings, preferably confectionary coatings, onto a substrate, which in preferred embodiments is at least partially edible. In a preferred embodiment, the confectionary composition used with the coating apparatus is fluidified when used, but when at room temperature (i.e., 68° F., 20° C.) the confectionary composition is solid, or highly viscous. When the confectionary composition is supplied to the apparatus, or part thereof, it may be heated to fluidify it and decrease its initial viscosity at room temperature, thus making it more flowable at its heated temperature or its ‘application temperature’ whereat it is applied to the surface of a substrate. Preferably then, the confectionary composition undergoes a change in viscosity; that is to say, if supplied as a solid confectionary composition it may be completely, or substantially fluidified or melted due to the action of the coating apparatus. Preferably, the coating apparatus includes a heat source which elevates the temperature of the confectionary composition sufficiently to cause its melting (fluidification) and a reduction of its room temperature viscosity. Preferably, the coating apparatus is configured to allow for the insertion of an edible substrate which is at least partially immersed in the fluidified confectionary composition such that, when withdrawn, the confectionary composition forms a coating adhered to at least part of the surface of the substrate. When removed from the container of the coating apparatus, the confectionary composition cools and reverts to a viscous, or solidified confectionary coating now present upon the substrate. In preferred embodiments, the finished coated confection, which comprises the confectionary coating upon the substrate is at least partially edible. Nonlimiting examples of such would be a completely edible substrate, such as a pretzel rod which had been previously independently formed, which is thereafter dipped into a fluidified confectionary composition which adheres to at least a part thereof.

The fluidified confectionary composition may be one or more of: chocolate, cheese, caramel, or any edible composition for that matter, such that when withdrawn from the fluidified confectionary composition at its elevated temperature when present within the operating coating apparatus, it cools and is retained in a solid or semi-solid form upon the substrate as at least a partial coating thereon. Of course, the coating may be essentially a complete coating, or enrobement of the substrate, such as would occur if the substrate were fully submerged or immersed within the fluidified confectionary composition. It is also foreseeable that subsequent to the application of a first, at least partial coating upon a substrate, that one or more further at least partial coatings may be applied upon one or more previously applied coatings of the substate. In such manner a series of coatings of the same, or different, confectionary compositions form sequential coating upon a substrate.

As discussed previously the coating apparatus is advantageously used to fluidify a confectionary composition, but in alternative embodiments and methods, the coating apparatus is used to fluidify a fluidifiable composition which may be an edible composition or an inedible composition, i.e., a wax. In particularly preferred embodiments, the fluidifiable composition may be limited to a confectionary composition.

In another preferred embodiment, only part of the finished coated confection is edible, and/or a portion of the finished coated confection includes an inedible component part which may be used to support a coated substrate, the latter being edible. By way of nonlimiting examples such could be, for example, a “cake pop” which includes a previously baked substrate which may be affixed to an inedible stick or rod (often made of wood, or a synthetic plastics material) which supports the said baked substrate, which at least part of the baked substate is then inserted into the fluidified confectionary composition; after being withdrawn from the operating coating apparatus, the applied coating of confectionary composition cools and is retained in a solid or semi solid form upon part or all of the previously baked substrate. The edible portions of this form of a finished coated confection may be consumed by a person, and thereafter the inedible part can be responsibly discarded.

In yet another preferred embodiment, the present invention may be used for inedible coatings such as wax or paraffin, such as would be useful in candle making, or tall aspect ratio cleaning such as jewelry and the like. It is to be understood that the aspects of the present invention are applicable to a variety of uses as understood by those skilled in the art.

In general, the (i) coating apparatus comprises a base, a heat source, a central cavity (and/or vessel) which may integral to base or which may be removable from the base, means for providing thermal energy, (i.e, a heat source, or a heater) to the central cavity in order to fluidify the contents of the central cavity when the coating apparatus is in operation, when within which is contained a fluidifiable composition which is fluidified in response to the heat source, wherein the central cavity has a maximum transverse distance “D” and a maximum height “L” requirement for the ratio between the maximum transverse distance “D” to the maximum height “L” of the central cavity is such that the ratio of D:L is at least 1:2.5, to as much as 1:15.

The (i) coating apparatus may take several different configurations. In a first configuration the coating apparatus comprises a base, a heat source and a non-removable central cavity, or “melt vessel” within which may be contained the confectionary composition, which is fluidified in response to the heat source. In a second configuration, the coating apparatus comprises a base and a heat source, and also a removeable cavity, and/or “melt vessel” within which may be contained the confectionary composition, which is fluidified in response to the heat source. In a third configuration, the coating apparatus comprises a base, and a removable cavity with a heat source, or a “melt vessel”. When the base is connected to the removable cavity with the heat source, the confectionary composition within the removable cavity is fluidified in response to the heat source, which may be activated by an interconnection to the base. In certain embodiments a central cavity may accommodate a melt vessel within the central cavity of the coating apparatus.

In a second aspect of the invention, there is provided (ii) one or more tools useful with the coating apparatus. One example is a reducing insert for use with a coating apparatus as described herein, or for use in methods of forming a finished coated confection and used independently of the specific coating apparatus described herein i.e., potentially with different coating apparatus than described and depicted herein. Another example is a cavity sleeve, insertable into the melt vessel for containment of the confectionary composition. The cavity sleeve is removable from the melt vessel, and when containing a quantity of confectionary composition may be used to store the same for a subsequent use, i.e., such as in a cabinet or at a reduced temperature, i.e, a refrigerator or freezer. Preferably the cavity sleeve is resealable and/or reusable, but single use cavity sleeves and/or non-sealable cavity sleeves are also within the scope of the present invention as well. The cavity sleeve, in another preferred embodiment, may be used as a piping bag for decorating pastries such as cakes and cookies. The end of the cavity sleeve could be cut to a preferred diameter hole for specific applications.

A third aspect of the invention is a kit. Kits may include the necessary components of a (i) coating apparatus, including such as described as a first, second, or third configuration, as well as hereinafter. Kits may comprise (ii) one or more tools, including at least one reducing insert and/or one or more cavity sleeves as described above, as well as one or more further tools as may be described hereafter. Kits may also include the necessary components of a (i) coating apparatus concurrently with (ii) one or more tools.

A fourth aspect of the invention is a method of forming a finished coated confection, comprising the application of a confectionary coating upon a substrate which is at least partially edible, when the confectionary coating is provided by a coating apparatus as described herein.

Various aspects of the invention may be understood from the attached drawings. The drawings illustrate different embodiments of the coating apparatus, as well as components used to form such coating apparatus. Common features are present in each of these, and are identified by the same reference numerals or letters.

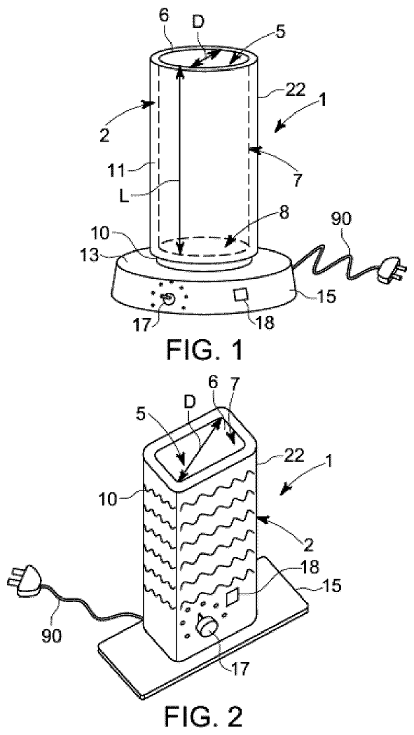

FIG. 1 depicts an embodiment of a coating apparatus.

FIG. 2 depicts an embodiment of coating apparatus, comprising a resistance wire.

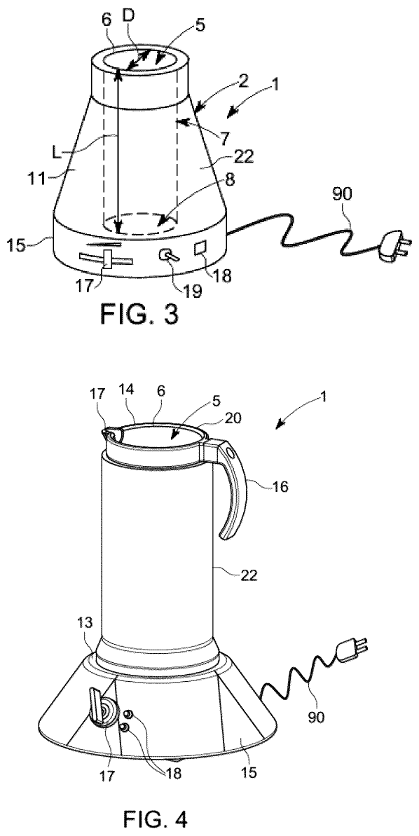

FIG. 3 depicts a further embodiment of coating apparatus.

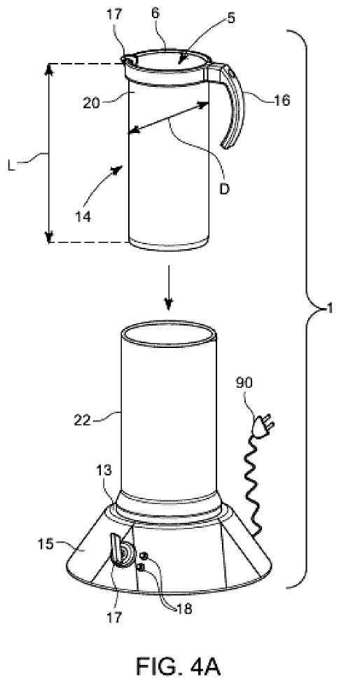

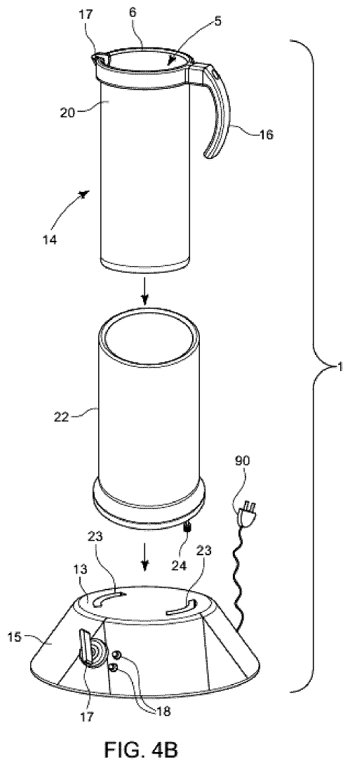

FIG. 4 depicts a yet further embodiment of coating apparatus.

FIG. 4A depicts a further embodiment of coating apparatus, which includes a removable vessel insertable into a jacket.

FIG. 4B depicts a further embodiment of coating apparatus, which includes a removable vessel insertable into a detachable jacket.

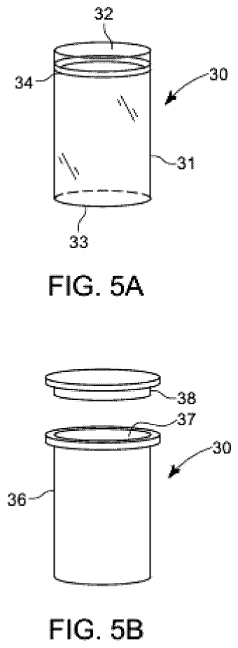

FIG. 5A depicts an embodiment of a removable, flexible liner.

FIG. 5B depicts an embodiment of a semi-rigid or substantially rigid removable liner.

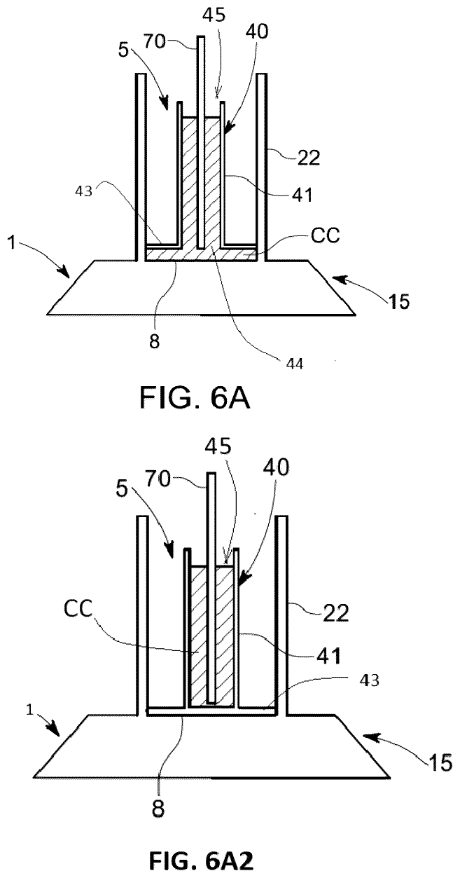

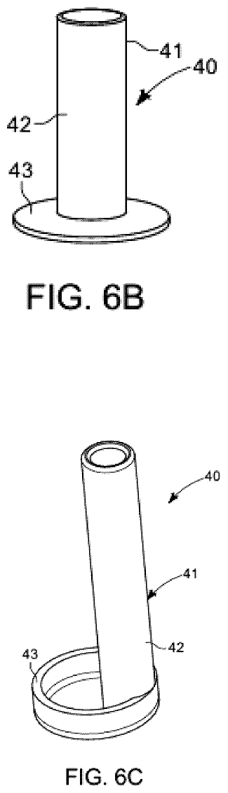

FIG. 6A illustrates a cross-sectional view of first embodiment of a reducing insert.

FIG. 6A2 depicts a further embodiment of a reducing insert.

FIG. 6B depicts a perspective view of the reducing insert of FIG. 6A.

FIG. 6C depicts a perspective view of the reducing insert having an non-concentric configuration.

Generally, a (i) coating apparatus 1 according to the invention is a powered coating apparatus which has a part which includes a central cavity 5, within a fluidified confectionary composition is contained, a heater 10, and optionally but most preferably also includes a base 15. In certain embodiments these may be separable from one another, such as to allow for cleaning or use of other similarly sized parts. The central cavity 5 may be integral to the coating apparatus 1, or it may be a removable vessel 20 (i.e., “melt vessel”) within which the confectionary composition is contained when the coating apparatus 1 is in use. When operating, the coating apparatus (1) fluidifies the confectionary composition due to the energized heater 10, and the continuously temperature controlled heater is used to maintain the confectionary composition in a melted or fluid state, such that substrates may be inserted within the fluidified confectionary composition.

Three different embodiments of a coating apparatus 1 are disclosed. The first embodiment of FIG. 1 illustrates a coating apparatus 1 having a pedestal base 15, at the top part 13 of which is present a heater 10, here in the form of a plate or surface which is connected to a power source 90 via which electrical power may be supplied to the coating apparatus 1. This said plate can be, without limitation, any source of thermal energy such as a resistance pad, resistance plate, or Peltier device. It is to be understood that the power source 90 may be self-contained, i.e., one or more batteries, or an electrical connection to battery pack or other external power source. Control over the operation of the coating apparatus 1 may be exerted via conventional electrical/electronic components, i.e., a variable resistor, potentiometer 17 which may also include an integrated on-off switch, one or more indicators 18 such as one or more status lights providing information indicative of the status, i.e., “on”, “off”, “ready”, “standby”, “heating”, and the like, as well as one or more switches 19, which are also acceptable alternatives. As is visible in FIGS. 1-3, the central cavity 5 is retained within an external jacket 22 which can be structure which maintains the central cavity 5 in an upright position, and its top end 6 open. The central cavity 5 extends within the external jacket 22 between its open end 6 and at the opposite side or end, a cavity base 8, and extending between the top end 6 and the cavity base 8 are one or more cavity sidewalls 7. A gap 11 may be present between the cavity sidewall 7, and external jacket 22. This gap 11 allows for the placement of a material or further device. Materials could include, without limitation, insulating material, supporting ribs, other physical structures. Further devices may include, such as shown in FIG. 2, the heater 10 here a resistance wire (i.e., nichrome) which, when carrying electrical currents heats up and imparts heat to cavity base 8 and/or cavity sidewall 7. With reference to FIG. 3, the heating device may be either a plate as described with reference to FIG. 1, or a resistance wire as described with reference to FIG. 2.

The operation of heater 10 controlled by a suitable electronic or electrical circuit. For example, in the embodiment of FIG. 1 a simple circuit is depicted having a variable resistor or potentiometer 17 which may also include an integrated on-off switch which is rotatable to set a particular temperature within the interior of the central cavity 5, and an (optional) status indicator 18, here an LED light, all powered by suitable power source 90, herein depicted as a cord and an electrical plug suitable for connecting to a domestic a/o commercial power source, typically between 110 V-240 V AC. An alternative power supply power source 90, such as one or more batteries, or connection to a DC power source. A further alternative power supply source 90 could be a steam jacket, a fluid (i.e., water) bath or a combustible heat source (i.e., combustible fuel source, candle, natural gas, propane). In FIG. 2 there is also similarly present a variable resistor or potentiometer 17 which may also include an integrated on-off switch which is rotatable to set a particular temperature within the interior of the central cavity 5, and an (optional) status indicator 18, here an LED light, which however are contained within a lower portion of the external jacket 22 which permits for the base 15 to be substantially a plate, which may be integrated or affixed to the external jacket 22, or removable therefrom. In FIG. 3, the shape of the external jacket 22 is flared or bell-shaped as it extends from the region near the open end 6, in the direction of the closed cavity base 8. The heater 10 (not shown) in FIG. 3 may similarly include a variable resistor or potentiometer 17 (here a sliding resistor or potentiometer, as opposed to one of a rotary configuration, which may also include an integrated on-off switch which is slideable to set a particular temperature within the interior of the central cavity 5, and an (optional) status indicator 18, here an LED light, all powered by suitable power source 90. The LED lights of the indicator 18 may be of different cause, for example one red, one green indicating an “unready” condition, and when illuminated, the green a “ready” condition.

It is to be understood that the variable resistor or potentiometer 17 which may also include an integrated on-off switch which is rotatable to set a particular temperature within the interior of the central cavity 5, and an (optional) status indicator 18 described with reference to the figures may be an electrical/electronic components and/or circuits (including integrated circuits and modules) which provide a similar or identical function, and may also provide further functions, i.e., displays (LED, LCD, panels) which provide status information such as time, temperature, a timer function, alarms, as well as unidirectional and/or bidirectional control functions such as near range communications (i.e., infrared, Bluetooth) and wireless communications with control devices, i.e., remote control units, cellphones, computers, computer networks, Internet communications, using appropriate protocols for such communications.

Optionally, one or more thermocouples, or temperature sensors may also be associated with any of the devices. These can be used to determine relevant temperatures, i.e., the sidewall 7 temperature of a central cavity 5, the temperature of a confectionary composition within a central cavity 5. One or more thermocouples or temperature sensors to be used to control the operation of the device, such as by interaction with a suitable electrical or electronic circuit associated with the respective device.

Optionally, the devices may include an integrated computer or electronic logic circuit and/or other electrical or electronic components used to power and/or control the operating characteristics of a device. Without limitation, this may be integrated computer which has inputs and outputs, the former for example being one or more thermocouples or temperature sensors, ambient temperature sensors, light sensors, and the latter being control signals or apparatus which is used in controlling the operating characteristics of the device. Such may for example be useful when a particular temperature profile over a unit period of time is desired. For example, for certain types of confectionary compositions, a rapid heat up time would be preferred as quickly liquefying the contents of the central cavity 5 without adversely affecting the taste, appearance, or other tangible characteristic of said confectionery different confectionary compositions. For these different, more temperature sensitive confectionary compositions, (i.e., chocolate) a more controlled thermal profile is desirable and may be preprogrammed into the integrated computer whereby, according to the program the integrated computer operates to control the operating characteristics of the devices.

Further and preferred embodiments of coating apparatus 1 are disclosed in FIGS. 4, 4A and 4B. FIG. 4 discloses a coating apparatus 1 which is formed from at least two separable components.

In the further and/or alternative embodiment of FIG. 4 is understood from FIG. 4A, wherein the coating apparatus 1 includes a base 15 and an integral jacket 22, within which may be inserted a separate vessel 14 comprising the central cavity 5. The interior of the vessel 14 delimits the central cavity 5 and its parts, and the vessel 14 further optionally but preferably also includes one or both of a handle 16, and a spout 17 proximate to the open end 6. As is to be understood from FIG. 4A, the dimensions of the vessel 14 are such that it removably insertable within the external jacket 22. While not shown, it is to be understood that the coating apparatus 1 includes a heater 10 suitably positioned and configured to provide energy, preferably thermal energy to the central cavity 5, such that a confectionary composition contained within may be fluidified. The provision of the embodiment of FIG. 4A allows for the use of two or more separate vessels 14, such as might be conveniently used when two or more different confectionary compositions are to be used. The separate vessel 14 may also be covered or sealed at the open end 6 during use, or prior to or between uses with a coating apparatus 1. Including a handle 16 and/or spout 17 facilitates handling of a confectionary composition particularly when it is fluidified.

In preferred embodiments the vessel 14 is comprised of a thermally transmissive material and with wall thickness such that the heat is conducted from the base to the top, maintaining a roughly uniform temperature of the side wall and the contained fluidified composition, preferably a fluidified confectionary composition, contained within the vessel 14.

A further and/or alternative embodiment of FIG. 4 is understood from FIG. 4B. Therein the coating apparatus 1 includes a base 15 and a detachable jacket 22, within which may be inserted a separate vessel 14 comprising the central cavity 5. The interior of the vessel 14 delimits the central cavity 5 and its parts, and the vessel 14 also optionally but preferably includes one or both of a handle 16, and a spout 17 proximate to the open end 6. As is to be understood from FIG. 4A, the dimensions of the vessel 14 are such that it removably insertable within the external jacket 22. While not shown, it is to be understood that the coating apparatus 1 includes a heater suitably positioned and configured to provide energy, preferably thermal energy to the central cavity 5, such that a confectionary composition contained within may be fluidified. In the embodiment, it is also to be understood that the detachable jacket 22 may be removed, and reaffixed to the base 15. Such a function may be accomplished by any means, including but not limited to: merely stacking the jacket 22 on top of a part of the base 15, by suitably dimensioning a part of the base 15 and a part of the removeable jacket 22 to provide an interference type fit, or friction fit. A preferred embodiment is shown in FIG. 4B; therein two correspondingly dimensioned keyhole slots 23 are provided extending through the top part 13 of the base 15, which mate with correspondingly configured key-pins 24 (only one shown in FIG. 4B) which engage the keyhole slots 23, and when the removable jacket 22 is partially rotated, it becomes coupled to the base 15. Counter-rotation would provide for decoupling of the jacket 22 from the base 15. A removeable jacket 22 may provide for easier cleaning of the coating apparatus 1. It is to be understood that in any embodiment of FIGS. 4, 4A, 4B, the heater 10 may be present in the base 15, at, near, or atop the top part 13 of the base 15. It is to be understood that in any embodiment of FIGS. 4, 4A, 4B, the heater 10 may be present in the jacket 22 of FIG. 4A, FIG. 4B.

It is also to be understood that the use of a suitably configured removeable vessel 14 may be used with any of the embodiments disclosed in any of the other drawing figures, including prior FIGS. 1, 2 and 3.

The central cavity 5 (when no removable vessel 14 is used) and the removable vessel 14 are advantageously formed using a thermally transmissive material such that they are in addition to being food safe, also can contain the fluidified desired confectionary composition within, a food grade polymer including but not limited to a polyolefin polymer including HDPE and copolymers, polyester such as PET or PBT and copolymers thereof, polysulfones and copolymers thereof, and/or a metallic material, i.e, a flexible foil, such as aluminum. Further, laminates of two or more different materials may also be used. In certain preferred embodiments the central cavity 5 and/or removable vessel 14 is comprised of a thermally conductive material and with wall thickness such that the vessel and contained confectionary composition (or other fluidfiable composition) is roughly isothermal over the full height of the central cavity a/o removable vessel.

A further feature of the invention is that there is a requirement for the ratio between the maximum transverse distance “D” to the maximum height “L” of this central cavity 5. For example, in the embodiments wherein the central cavity 5 is concentric, and is substantially cylindrical, “D” is the diameter and “L” is the distance between the open end 6 and the cavity base 8. This ratio of D:L is at least 1:2.5, to as much as 1:15, but preferably in the range of 1:3 to 1.8. Preferably, and in order of increasing preference the D:L ratios are at least 1:2.5, 1:3, 1:3.5, 1:4, 1:4.5, 1:5, 1:5.5, 1:6, 1.6.5, 1:7, and 1:7.5.

A further feature of the invention is the configuration of the high aspect ratio removable vessel, 14 or insert 40, which may be either concentric or eccentric. In the case of an insert, 40 a hollow tube may be concentric with a base of the insert or may be offset from the center part of the insert 40. Since the confectionary contained in the removable vessel must be kept fluidified at a suitable temperature as determined by the temperature control settings, the vessel in preferred embodiments is substantially isothermal over its full height. The heater, 10, is located at the bottom of the cavity base in some preferred embodiments, so it is necessary for the vessel to be designed with a thick wall of thermally conducting material such as aluminum, copper, aluminum nitride ceramic or thermally conductive polymer. This allows heat to be conducted along the full height of the vessel maintaining a roughly isothermal wall temperature as well as isothermal temperature of the contained confectionary even for very tall aspect ratio vessels, i.e. 1:7.5.

As shown in FIGS. 1 and 3, the shape of the central cavity C is generally cylindrical, while in FIG. 2 the central cavity has a substantially square (but may be rectangular) cross-section, a maximum transverse distance D (which may be a diameter, also “D”), and a height L. In the embodiments which include a vessel 14, then “D” and “L” are determined from the dimensions and geometry of the central cavity 5 of the vessel 14. Also, in preferred embodiments the maximum transverse distance is preferably not in excess of 5 inches, and more preferably is between 1 and 5 inches, preferably not more than 4 inches, and in some instances not more than about 3 inches. It is to be understood that other configurations for the central cavity are possible. The central cavity 5 thus inherently defines a volume and this too can vary widely. Preferably, the volume is between about 1 fluid ounces to about 54 fluid ounces, more preferably the volume of the central cavity C is between about 4 and 32 fluid ounces, 4 to 24 fluid ounces.

A further aspect of the invention relates to (ii) tools useful with the coating apparatus.

One such tool is removable liner 30 which may be used in conjunction with coating apparatus 1. A first embodiment thereof is a flexible version of a liner 30, as shown on FIG. 5A. The liner 30 is formed of a flexible material, which is food grade, and as depicted is preferably a resealable flexible pouch 31. Such may for example be a food grade polymer including but not limited to a polyolefin polymer including HDPE and copolymers, polyester such as PET or PBT and copolymers thereof, polysulfones and copolymers thereof, and/or a metallic material, i.e, a flexible foil, such as aluminum. Further, laminates of two or more different materials may also be used to form the flexible pouch 31, it only being required that the innermost layer which would come into physical contact with a confectionary composition be food grade. The flexible pouch 31 includes an openable end 32, at an opposite part or end, a base 33; proximate to the end 32 is a reopenable seal, here the preferred interlocking “zip-lock” which is openable and closeable a number of times without compromising the performance thereof. The flexible pouch 31 is preferably suitably dimensioned to be retained in a central cavity 5 and this is necessarily tolerant of elevated temperatures, i.e., the fluidification temperature of a confectionary composition being used with the flexible pouch 31 and the coating apparatus 1. It is to be understood that the flexible pouch 31 may be used in place of a vessel 14 in any of the other embodiments as described herein.

Another tool as depicted on FIG. 5B is a liner 30 which is a semi-rigid or substantially rigid removable liner 36. This vessel is also formed of a food grade material, which also may be a polyolefin polymer including HDPE and copolymers, polyester such as PET or PBT and copolymers thereof, polysulfones and copolymers thereof, and or a metallic material, such as stainless steel, aluminum, or other. Similarly laminates of two or more different materials may also be used to form the liner 36, it only being required that the innermost layer which would come into physical contact with a confectionary composition be food grade, and that the thickness and thermal conductivity of the liner be such as to not impede the heating of the confectionary. An open end 37 may be sealed with a cap 38 which it insertable within, or upon the open end 37. The removeable liner 36 is preferably suitably dimensioned to be retained in a central cavity 5 and this is necessarily tolerant of elevated temperatures, i.e., the fluidification temperature of a confectionary composition being used with the flexible liner 36 and the coating apparatus 1. It is to be understood that the flexible liner 36 may be used in place of a vessel 14 in any of the other embodiments as described herein.

A further (ii) tool useful with a coating apparatus of the invention is a reducing insert 40. This reducing inset 40 may itself function wholly separately from a coating device as disclosed herein, i.e, it may be interested into a water bath at an appropriate temperature or within a dispensing device, as the reducing insert 40 is in preferred embodiments, self-standing. FIGS. 6A and 6B depict views of a first embodiment of a reducing insert 40, having a concentric configuration. FIG. 6C depicts a second embodiment of a reducing insert 40, having a non-concentric configuration (“offset” configuration.) FIG. 6A provides a sectional view of reducing insert 40 positioned within the central cavity 5 of the coating apparatus 1 of FIG. 1. The reducing insert 40 provides for a more efficient utilization of the confectionary composition CC being applied to substrates, particularly where the substrate has a long linear dimension i.e, a pretzel rod, 70 having a length much greater than its width, and being generally cylindrical in its configuration. The use of a reducing insert 40 in conjunction with a coating apparatus 1 effectively reduces the volumetric size of the central cavity 5s so to maximize the utilization of the confectionary composition CC with the cavity 5. With attention now to the cross-sectional view of FIG. 6A, the reducing insert 40 comprising a central and hollow column 41 having a continuous sidewall 42 extending upwardly from a base 43; the hollow column 41 advantageously has a height or an overall length which may be the same as, greater than, or less than the length L of the central cavity 5 (see FIGS. 1, 3) and/or the vessel 14 (see FIG. 4A). The overall configuration of the reducing insert 40 is such that when a quantity of the confectionary composition CC falls to an undesirable or difficult to use level within the central cavity 5, the reducing insert 40 may be inserted within. The reducing insert 40 is pushed downwardly so to compress the remaining quantity of the confectionary composition CC so that it is forced upward within the hollow column 41. The dimensions of the base 43 should provide a close fit within the central cavity 5. Thus, the confectionary composition CC assumes a greater height than without the reducing insert 40. This displaces the confectionary composition CC, and forces it away from the cavity base 8. The overall volumetric dimensions of the central cavity 5 are thus effectively, and temporarily, reduced and importantly are concurrently, a higher column of the confectionary composition CC is provided by the reducing insert 40. The increased column height of the fluidified confectionary composition allows for a deeper insertion by a substrate, i.e, the depicted pretzel rod 70. In one embodiment, FIG. 6C operates in a manner essentially the same as that described with reference to FIGS. 6A, 6B, but is of a different “offset” configuration. In the embodiments shown in FIG. 6A, the hollow column 41 is in fluid communication with the interior of the central cavity 5, and thus when inserted into the central cavity the fluidifiable composition, here a confectionary composition CC, enters via an open bottom end 44 of the hollow column 41 proximate to or coincident with the base 43, and is urged to the open top end 45, through which a substrate may be inserted into the fluidifiable composition.

According to an alternative matter of usage, a reducing insert 40 may be provided and inserted into the central cavity 5 or vessel 14 when a coating apparatus 1 is initially prepared for use. Thereby a mass of the desired confectionary composition CC (or other fluidifiable composition) would be supplied only into the interior of the reducing insert 40, particularly into the hollow column 41 when the base 43 is seated on or abutting the cavity base 8. Thus, improved energy efficiency and less potential wastage of confectionary composition needs to be used. It is to be understood that the illustrated reducing insert 40 may assume a different configuration, i.e., have one or more additional hollow columns 41 and/or have non-cylindrical hollow columns 41.

A further alternative usage of a reducing insert 40, which in this instance may represent a ‘stand alone’ type device which may be used wholly apart from a coating apparatus 1 is depicted in FIG. 6A2, which includes many of the same features described with reference to FIG. 6A. In FIG. 6A2, the hollow column 41 is not in fluid communication with the interior of the central cavity 5, and thus when inserted into the central cavity the fluidifiable composition, no confectionary composition CC, enters via an open bottom end 44 of the hollow column 41 proximate to or coincident with the base 43, and is urged to the open top end 45. Rather as is seen in the drawing, hollow tube 41 depends from the base 43, and thus the contents of the interior of the hollow column 41 is physically isolated from any materials (solid, fluid, gas) which may be present in the central cavity 5. In this embodiment the reducing insert 40 may be used with, or without a coating apparatus 1, as it is foreseeable that the base 43 provides sufficient support to avoid unwanted tipping of the hollow column 41 when in use, and thus such an embodiment may be placed in fluid heating bath, i.e. boiling water, or other temperature controlled fluid bath or material, or may itself be directly heated in the manner described previously. In this embodiment, the fluidifiable material, enters and exits the interior of the hollow column via the open top end 45 thereof.

The reducing insert 40 as shown on FIG. 6B may be understood to have a hollow column 41 and an open base 43, as disclosed in FIG. 6A, or with a closed base 43, as disclosed in FIG. 6A2.

While the reducing insert 40 may be made of any formable material, including but not limited to metals, metallized plastics, plastics, ceramics, glass, wherein heat transfer via the material of construction of the reducing insert 40 is one which generally has thermal transmissive properties, and especially preferred would be one or more metals, of which safer food grade metals. The heater, 10, is located at the bottom of the cavity base in some preferred embodiments, so it is necessary for the reducing insert to be designed with a thick wall of thermally conducting material such as aluminum, copper, aluminum nitride ceramic or thermally conductive polymer. This allows heat to be conducted along the full height of the vessel maintaining a roughly isothermal wall temperature as well as isothermal temperature of the contained confectionary even for very tall aspect ratio vessels, i.e. 1:7.5, and even higher ratios. In preferred embodiments A further feature of the invention is that there is a requirement for the ratio between the maximum transverse distance “D” to the maximum height “L” of this hollow column 41. For example, in the embodiments wherein the hollow column 41 is concentric, and is substantially cylindrical, “D” is the diameter and “L” is the distance between the open end 6 and the cavity base 8. This ratio of D:L is at least 1:2.5, to as much as 1:15, but preferably in the range of 1:3 to 1.15. Preferably, and in order of increasing preference the D:L ratios are at least 1:2.5, 1:3, 1:3.5, 1:4, 1:4.5, 1:5, 1:5.5, 1:6, 1.6.5, 1:7, and 1:7.5. The maximum transverse distance “D” and the maximum height “L” as a corollary to the depiction of FIG. 1 which explains such with reference to the central cavity 5, but which are transposed to the hollow column 41.

In preferred embodiments the reducing insert 40 is comprised of a thermally transmissive material and with wall thickness such that the heat is conducted from the base to the top, maintaining a roughly uniform temperature of the side wall and the contained fluidified composition, preferably a fluidified confectionary composition.

As noted, the reducing insert 40 may itself function as a coating apparatus in its own right.

Also, it is to be understood that reducing insert 40 may be variously configured, and are not necessarily limited by the embodiments disclosed herein but still fall within the scope and spirit of the invention. For example, it is possible to include a plurality of hollow columns 40, and any such hollow column may also differ from being generally circular as shown, to having different cross-sectional geometries. Furthermore, the specific reducing insert 40 may be varied to suit the geometries of any type of coating apparatus, which too are not to be limited to those disclosed in this application.

In a further aspect of the invention there is provided a (iv) method of use of any of the foregoing (i) a coating apparatus, adapted for the application of fluidifiable compositions, preferably of fluidified confectionary compositions onto edible substrates; (ii) tools useful with the coating apparatus.

In the method relating to the use of (i) coating apparatus, the method comprises:
providing a coating apparatus as described herein;
providing to the interior of the central cavity or to the interior of a vessel used in conjunction with the coating apparatus, or to the interior of a removable liner, a quantity of a fluidifiable composition, especially preferably a confectionary composition;
operating the coating apparatus to fluidify the fluidifiable composition;
contacting a substrate, preferably an edible substrate, with the fluidifiable composition to provide a coating or quantity of the fluidified composition onto the substrate, preferably an edible substrate.

In the further method relating to the use of (i) coating apparatus, the method comprises:
utilizing a coating apparatus as described herein;
providing to the interior of the central cavity or to the interior of a vessel used in conjunction with the coating apparatus, or to the interior of a removable liner, a quantity of a fluidifiable composition, preferably a confectionary composition;
operating the coating apparatus to fluidify the fludifiable composition, preferably a confectionary composition;
contacting a substrate, preferably an edible substrate, with the fluidified composition to provide a coating or quantity of the fluidified composition onto the substrate, preferably an edible substrate.

In the further method relating to the use of (i) coating apparatus, the method comprises:
providing or utilizing a coating apparatus as described herein, with a reducing insert as described herein;
providing to the interior of the central cavity or to the interior of a vessel used in conjunction with the coating apparatus, or to the interior of a removable liner, the reducing insert and a quantity of a fluidifiable composition, preferably a confectionary composition;
operating the coating apparatus to fluidify the fluidifiable composition;
contacting a substrate, preferably an edible substrate, with the fluidified composition to provide a coating or quantity of the fluidified composition onto the substrate, preferably an edible substrate.

1. A coating apparatus comprising a base, a heat source, a central cavity which may integral to base or which may be removable from the base, means for providing thermal energy to the central cavity in order to fluidify the contents of the central cavity when the coating apparatus is in operation, when within which is contained a fluidifiable composition which is fluidified in response to the heat source, wherein the central cavity has a maximum transverse distance “D” and a maximum height “L” requirement for the ratio between the maximum transverse distance “D” to the maximum height “L” of the central cavity is such that the ratio of of D:L is at least 1:2.5, to as much as 1:15.

2. The coating apparatus of claim 1, wherein the ratio of D:L is in the range of 1:3 to 1.8.

3. The coating apparatus of claim 2, wherein the ratio of D:L is in the range of 1:5 to 1.8.

4. The coating apparatus of claim 1, wherein the central cavity is removable from the base.

5. The coating apparatus of claim 1, wherein the fluidifiable composition is a confectionary composition.

6. The coating apparatus of claim 1, wherein a removable vessel is provided made of thermally conductive material and with wall thickness such that the vessel and contained confectionary composition is roughly isothermal over the full height of the vessel.

7. A method of utilizing the coating apparatus of claim 1, the method comprising the steps of:
providing to the interior of the central cavity or to the interior of a vessel used in conjunction with the coating apparatus, or to the interior of a removable liner, a quantity of a fluidifiable composition, especially preferably a confectionary composition;
operating the coating apparatus to fluidify the fluidifiable composition;
contacting a substrate, preferably an edible substrate, with the fluidifiable composition to provide a coating or quantity of the fluidified composition onto the substrate, preferably an edible substrate.

8. A method of utilizing the coating apparatus of claim 1, the method comprising the steps of:
providing to the interior of the central cavity or to the interior of a vessel used in conjunction with the coating apparatus, or to the interior of a removable liner, a quantity of a fluidifiable composition, preferably a confectionary composition;
operating the coating apparatus to fluidify the fluidifiable composition, preferably a confectionary composition;
contacting a substrate, preferably an edible substrate, with the fluidified composition to provide a coating or quantity of the fluidified composition onto the substrate, preferably an edible substrate.

9. A method of utilizing the coating apparatus of claim 1, the method comprising the steps of:
providing to the interior of the central cavity or to the interior of a vessel used in conjunction with the coating apparatus, or to the interior of a removable liner, the reducing insert and a quantity of a fluidifiable composition, preferably a confectionary composition;
operating the coating apparatus to fluidify the fluidifiable composition;
contacting a substrate, preferably an edible substrate, with the fluidified composition to provide a coating or quantity of the fluidified composition onto the substrate, preferably an edible substrate.

10. A reducing insert which reduces the volumetric capacity of the central cavity of the coating apparatus according to claim 1.

11. A reducing insert or vessel according to claim 9 constructed of thermally transmissive material and with wall thickness such that the heat is conducted from the base to the top, maintaining a roughly uniform temperature of the side wall and the contained fluidified composition.

12. A kit comprising at least one reducing insert and/or one or more cavity sleeves, adapted to be inserted into the central cavity of the coating apparatus according to claim 1.

13. A kit comprising at least one reducing insert having either an open base, or a closed base.
